(19) United States
(12) Patent Application Publication
(10) Pub. No.: US 2005/0091047 A1
(43) Pub. Date: Apr. 28, 2005

(54) Method and apparatus for network communication

(76) Inventors: Jonathan A. Gibbs, Southampton (GB); James P. Ashley, Naperville, IL (US); Halil Fikretler, Basingstoke (GB); Mark A. Jasiuk, Chicago, IL (US); Michael J. McLaughlin, Palatine, IL (US)

Correspondence Address: MOTOROLA, INC., 1303 EAST ALGONQUIN ROAD, IL01/3RD, SCHAUMBURG, IL, 60196, US

(21) Appl. No.: 10/694,574

(22) Filed: Oct. 27, 2003

(51) Int. Cl. G10L 19/00

(52) U.S. Cl. 704/219

(57) ABSTRACT

The present invention provides a method of tandem communication between at least a first portion of a network suitable for voice communications and a second portion of a network suitable for voice communications. In an embodiment of the present invention, a common data format is applied to an encoded signal produced by a codec of the first portion of a network. Upon application, the common data format comprises quantised parameters of the encoded signal and descriptors characterising the coding scheme of the first codec.

### TECHNICAL FIELD

The invention relates to a method and apparatus for network communication. In particular, it relates to a method and apparatus for tandemming network communications.

### BACKGROUND

Mobile telecommunications networks can choose between a large number of encoding and decoding schemes (codecs) for speech transmission. However, when two networks select different codecs (or different parts of the same network select different codecs), then communications between those two entities requires tandemming.

For example, a coding sequence between a CDMA (code division multiple access) mobile phone and a GSM (global system for mobile communication) mobile phone may be as follows:
i. A CDMA mobile phone on a first network encodes speech with CDMA codec 1.
ii. Codec 1 encoded speech is transmitted to a CDMA base station.
iii. The CDMA Base station decodes the codec 1 speech and encodes the result using PCM (pulse code modulation).
iv. The PCM encoded speech is transmitted via a wire-line to second, GSM, network.
v. A GSM base station of the second network decodes the received PCM speech and encodes the result using GSM codec 2.
vi. Codec 2 encoded speech is transmitted to a GSM mobile phone on the second network.

Thus in the above tandemming arrangement, the low bandwidth, high compression codecs used for wireless transmission are linked by a common high bandwidth, low compression PCM encoding scheme for the wireline part of the communication.

However, the resulting end-user received speech tends to be of poor quality. The primary reason is that speech reconstructed from one high compression codec is generally not ideal as input to another high compression codec. Such codecs typically generate high-level parameterisations of the speech with minimal redundancy, with the result that the reconstructed speech used by the PCM contains regularities and approximations not found in the original. A second codec seeking to generate a slightly different set of high-level parameterisations will find that the salient characterising information it assumes to be present has been removed or just interpolated by the first codec. The result is a poor representation of the speech by the second codec.

Currently, the concept of tandem-free operation (TFO) addresses this problem (see ETSI, “Technical Specification Digital cellular telecommunications system (Phase 2+); Universal Mobile Telecommunications System (UMTS); Inband Tandem Free Operation (TFO) of speech codecs; Service description; Stage 3 (3GPP TS 28.062 version 5.3.0 Release 5)” ETSI TS 128 062 V5.3.0 (2002-12)).

However, it only does so if the two networks have the same codec available. That is, the same access technology or compatible (e.g. between AMR (adaptive multi-rate) capable GSM networks and 3GPP (third generation partnership project) networks), and additionally only if end-to-end negotiation on call set-up is possible.

Thus it is not applicable when dissimilar codecs are used or when end-to-end negotiation is not possible or not implemented.

Dilithium Networks also provide a solution to the problems raised by tandemming, known as Unicoding™. (http://www.dilithiumnetworks.com/technology/voice.ht m).

This solution requires that one of three alternatives be pursued: Either the first codec's data is conveyed to the second network prior to translation to it's codec format, or that the data is translated in the first network to the second codec's format before being sent to the second network, or that the data from the first codec is routed to a proxy server to perform the translation and then routed from the proxy server to the second network.

Referring to FIG. 1, Unicoding employs CELP (code excited linear predictive) codec parameter translation from one codec data format 110 to another 130 and requires dedicated translation modules 120, 130 to be available for all possible codec to codec permutations.

This is not a simple solution however as, for example, just for 3GPP2 to GSM networks this would require Unicoding translation modules to be available to and from each of the four 3GPP2 codecs (IS-733, IS-96A, EVR (enhanced variable rate) and SMV (selectable mode vocoder)) to and from each of the three GSM codecs (Full-Rate, Half-Rate and AMR including EFR (enhanced full rate)). These twelve permutations are then further compounded by the multiple available modes for SMV (2 or 3 likely deployment modes) and the 10 modes of AMR, increasing the permutations to 60 or 72. Whilst there would be significant commonality between many of these, the problems of developing and deploying a large number of Unicoding translation modules over a number of networks, and the process of redeployment upon the introduction of any new codecs makes the solution appear unwieldy.

Many of the principles applied in the Dilithium Networks solution can also be found in H-G. Kang, H. K. Kim & R. V. Cox, “Improving Transcoding Capability of Speech Coders in Clean and Frame Erasured Channel Environments,” Proceedings of the 2000 IEEE Workshop on Speech Coding, 2000.

There appears to still be a need for an alternative method of tandem communication that provides both improved voice quality and a simple means of operation across one or more networks.

The purpose of the present invention is to address the above problems.

### SUMMARY OF THE INVENTION

The present invention provides a method of tandem communication between at least a first portion of a network suitable for voice communications and a second portion of a network suitable for voice communications.

In a first aspect, the present invention provides a method of tandem communication, as claimed in claim 1.

In a second aspect, the present invention provides a method of tandem communication, as claimed in claim 8.

In a third aspect, the present invention provides apparatus for tandem communication, as claimed in claim 12.

In a fourth aspect, the present invention provides apparatus for tandem communication, as claimed in claim 13.

Further features of the present invention are as defined in the dependent claims.

Embodiments of the present invention will now be described by way of example with reference to the accompanying drawings, in which:

### BRIEF DESCRIPTION OF THE DRAWINGS

FIG. 1 is a block diagram showing a tandem communication method in the prior art.

FIG. 2 is a block diagram showing a tandem communication method in accordance with an embodiment of the present invention.

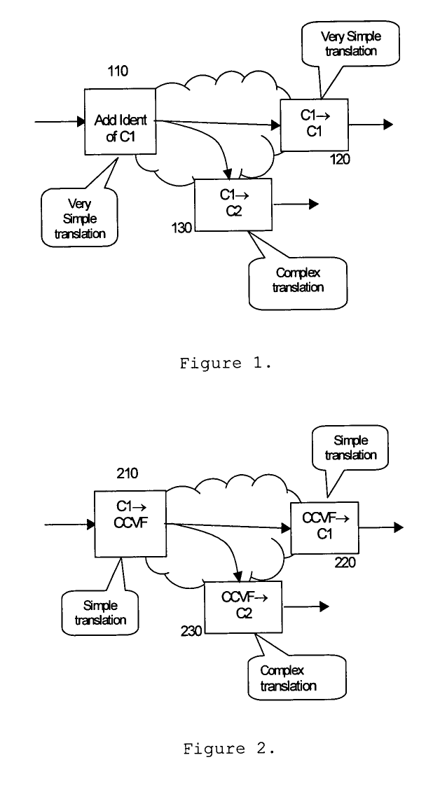

### DETAILED DESCRIPTION

Referring to FIG. 2, a method of tandem communication is proposed between at least a first portion of a network suitable for voice communications and a second portion of a network suitable for voice communications. These portions may be parts of the same or separate networks.

The inventors of the present invention have appreciated that an alternative to low-compression, high-bandwidth PCM speech coding may be employed that obviates the need for decoding data from a first codec into PCM speech, and then re-encoding it using a second codec.

This alternative, named the common compressed voice format (CCVF), is a common data format intended to take advantage of the fact that the majority of codecs currently in use are of the CELP variety. The CCVF provides a common form of representation for any such codec that it supports.

The CCVFs common form of representation allows a single, complex translation module 220, 230 to take in the CCVF representation and output the relevant second codec representation without the combinatorial problems experienced by the separate translation modules of the Dilithium Unicoding™ solution.

Moreover, when a network provider introduces a new codec, the onus is solely on that network provider to update their own version of the CCVF encoder 210 and converse translation module 220; Other networks will be able to use the CCVF representation so produced without modification, and naturally only the network provider itself requires CCVF translation back to the new codec. This greatly simplifies the deployment and maintenance of a tandemming solution.

Thus, in an embodiment of the present invention, a common data format is applied to an encoded signal that has been produced by a codec of the first portion of a network (hereinafter ‘first codec’).

The CCVF encoder 210 applying the common data format comprises means for quantising parameters of the data encoded by a codec, as well as means for describing the type of codec scheme used to encode the data.

Thus upon application to a first codec, the common data format comprises quantised parameters of the encoded signal produced by the first codec and descriptors characterising the coding scheme of the first codec.

Specifically, the common data format may describe any or all of the following coding scheme characteristics;
i. The type of quantisation format for LPC (linear predictive coding) sets;
ii. The number of LPC sets quantised per frame;
iii. The order of the LPC iv. The number of LPC interpolations per frame; V. The type of interpolation rules for the LPCs;
vi. The number of sub-frames per frame for LTP updates;
vii. The number of sub-frames per frame for codebook updates;
viii. The type of pitch sharpening present, if any; and
ix. The type of codebook encoding format.

Similarly, the common data format may include any or all of the following encoded signal parameters;
i. LPC vector;
ii. lag durations;
iii. LTP gain;
iv. pitch sharpening coefficient;
v. fixed codebook components; and
vi. codebook gains.

The above characteristics typically apply to CELP based codecs, but it will be clear to a person skilled in the art that these lists can be altered to include other encoded signal parameters and coding scheme characteristics as necessary.

To illustrate the CCVF encoder 210, a specific example is given below for encoding GSM EFR:

Descriptors for coding scheme characteristics:

| Descriptor | No. bits used |
|---|---|
| Quantization format of LPC sets = | 2 |
| Number of LPC sets quantized per frame = | 2 |
| Number of LPC Interpolations per frame = | 3 |
| Interpolation rules for the LPCs = | 4 |
| Number of subframes per frame for LTP updates = | 3 |
| Number of subframes per frame for Codebook updates = | 3 |
| Pitch Sharpening Present = | 1 |
| Codebook Encoding format = | 3 |

Quantised parameters of the encoded signal:

| Parameter | No. bits used |
|---|---|
| LPC Vector Quantised 2 × frame @ 50 bits -> 2 × 50 = | 100 |
| Lags 4 × frame @ 10 bits -> 4 × 10 = | 40 |
| LTP Gain 4 × frame @ 8 bits -> 4 × 8 = | 36 |
| Pitch Sharpening Coefficient 4 × frame -> 4 × 8 = | 36 |
| (Optional in GSM EFR) | |
| Ternary Coded Excitation (160 samples) -> 254 = | 254 |
| (Losslessly coded) | |
| Codebook Gains 4 × frame @ 10 bits -> 4 × 10 = | 40 |
| Total Bits = | 498 |

(Bit rate of 24.9 kb/s.)

Thus the format of the GSM EFR scheme is described using a small number of bits to specify coding scheme details such as the use of 2 LPC vectors per frame, or that the codebook format is ternary coded excitation. The coding scheme details need not be transmitted with every frame, though they can be if desired. Typically the various parameters of the encoded signal are quantised with little or no compression.

Note that in theory it would be desirable for the CCVF formatting to be able to accommodate all possible parameterisations and descriptors. Whilst the characteristics of current and likely CELP codecs may easily be anticipated and included, clearly any codec representing a significant departure from the CELP model may necessitate the introduction of an updated CCVF. This in turn would necessitate an update of all translation software across networks. However, the inventors of the present invention consider that this would be an infrequent event. Moreover, such changes to the CCVF may be avoided by using the parameterisations and descriptors currently included as part of the CCVF to encode the synthetic speech from the first codec, though clearly this encoding-translation will be sub-optimal.

The resulting CCVF representation of the encoded speech is transmitted over a wireline (landline) in lieu of a PCM signal. The wireline may further be part of a public switched telephone network or a packet switched network.

A second portion of a network, the second portion either being part of the same overall network as the first portion, or part of a separate network, then receives the CCVF representation.

A base station or other suitable apparatus 220, 230 within the second portion then performs codec parameter translation from the common compressed voice format 210 into an encoded signal compatible with a second codec format supported by the second portion of the network, requiring dedicated code to be available for the supported codec.

If the second codec is the same as the first codec, the step of translation simply comprises dequantising the common data format representation and substantially reconstituting the original encoded signal.

If the second codec is different to the first codec, the step of translation comprises dequantising the common compressed voice format representation and applying a conversion process to convert components of the encoded signal produced by the first codec into components compatible with the second codec.

For example, the first codec may represent line spectral frequencies (LSFs) using a first quantisation scheme; the conversion process dequantises the LSFs according to the first scheme, and then quantises them according to a scheme of the second codec. By this method the second codec obtains parameters of the original speech without the inherent problems of encoding reconstructed speech discussed previously.

The main benefit of this approach over the prior art is that the translation is from a single common data format (the common compressed voice format), rather than from a disparate group of codecs. By decomposing individual codecs into their constituent parameters in a prescribed fashion, the CCVF removes the need to treat each codec as an individual entity and so avoids the combinatorial problems seen in the prior art.

In an embodiment of the present invention, apparatus 210 for tandem communication comprises application means to apply a common data format to an encoded signal produced by a codec.

The apparatus 210 implementing the application of the common data format comprises means for quantising parameters of the data encoded by a codec, as well as means for describing the type of codec scheme used to encode the data.

In an embodiment of the resent invention, apparatus 220, 230 for tandem communication comprises conversion means for converting a common data format representation of an encoded signal into an encoded signal compatible with at least a first specific codec.

1. A method of tandem communication between at least a first portion of a network suitable for voice communications and a second portion of a network suitable for voice communications,
characterised by the step of;
applying a common data format to an encoded signal, the encoded signal produced by a codec of the first portion of a network (hereinafter ‘first codec’), and wherein;
upon application the common data format comprises quantised parameters of the encoded signal produced by the first codec and descriptors characterising the coding scheme of the first codec.

2. A method according to claim 1 wherein the first portion of a network suitable for voice communications and the second portion of a network suitable for voice communications are part of the same overall network.

3. A method according to any one of claims 1 and 2 wherein any or all of the following set of coding scheme characteristics are described in accordance with the common data format;
i. Type of quantisation format for linear predictive coding (LPC) sets;
ii. number of LPC sets quantised per frame;
iii. the order of the LPC
iv. number of LPC interpolations per frame;
V. type of interpolation rules for the LPCs;
vi. number of sub-frames per frame for LTP updates;
vii. number of sub-frames per frame for codebook updates;
viii. type of pitch sharpening present, if any; and
ix. type of codebook encoding format.

4. A method according to any one of the preceding claims wherein any or all of the following set of encoded signal parameters are quantised in accordance with to the common data format;
i. LPC vector;
ii. lag durations;
iii. LTP gain;
iv. pitch sharpening coefficient;
V. fixed codebook components; and
vi. codebook gains.

5. A method according to any one of the preceding claims, further comprising the step of;
transmitting the common data format representation of the encoded signal to a second network via a wired link.

6. A method according to claim 5 wherein the wired link is part of a public switched telephone network.

7. A method according to claim 5 wherein the wired link is part of a packet switched network.

8. A method of tandem communication between at least a first portion of a network suitable for voice communications and a second portion of a network suitable for voice communications,
characterised by the step of;
translating a common data format representation of an encoded signal produced by a codec of a first portion of a network into an encoded signal compatible with a codec of the second portion of a network (hereinafter ‘second codec’).

9. A method according to claim 8 wherein the first portion of a network suitable for voice communications and the second portion of a network suitable for voice communications are part of the same overall network.

10. A method according to any one of claims 8 and 9 wherein if the second codec is the same as the first codec, the step of translation comprises dequantising the common data format representation and substantially reconstituting the original encoded signal.

11. A method according to any one of claims 8 and 9 wherein if the second codec is different to the first codec, the step of translation comprises dequantising the common compressed voice format representation and applying a conversion algorithm to convert components of the encoded signal produced by the first codec into components compatible with the second codec.

12. Apparatus for tandem communication between at least a first portion of a network suitable for voice communications and a second portion of a network suitable for voice communications according to a method as claimed in any one of claims 1 to 7, and comprising;
application means to apply a common data format to an encoded signal, the encoded signal produced by a codec of the first portion of a network (hereinafter ‘first codec’), and wherein;
the common data format comprises quantised parameters of the encoded signal produced by the first codec and descriptors characterising the coding scheme of the first codec.

13. Apparatus for tandem communication between at least a first portion of a network suitable for voice communications and a second portion of a network suitable for voice communications according to a method as claimed in any one of claims 8 to 11, and comprising;
translation means for translating a common data format representation of an encoded signal into an encoded signal compatible with a codec of the second portion of a network.

14. A method according to claim 1 and substantially as hereinbefore described with reference to the accompanying drawings.

15. A method according to claim 8 and substantially as hereinbefore described with reference to the accompanying drawings.
